(19) United States
(12) Patent Application Publication
(10) Pub. No.: US 2010/0039661 A1
(43) Pub. Date: Feb. 18, 2010

(54) SYSTEM AND METHOD FOR REMOTE FACSIMILE MESSAGE RETRANSMISSION

(76) Inventors: Kenneth Stephenson, San Clemente, CA (US); Louis Ormond, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/191,709

(22) Filed: Aug. 14, 2008

(51) Int. Cl. G06F 3/12

(52) U.S. Cl. 358/1.15

(57) ABSTRACT

The subject application is directed to a system and method for remote facsimile message retransmission. At least one document and identification data corresponding to a user are received for association with a facsimile transmission. Destination address data is then received, and facsimile transmission is commenced. Whether the transmission is successful is monitored, and a notification message is generated to the user, which message includes information relative to the monitored transmission of the document. Login data associated with the document is then received from an associated thin client interface. Update data, corresponding to an output of the monitoring that indicates a failure of a facsimile transmission of the at least one document in accordance with received address data, is received via the thin client interface. A facsimile retransmission, electronic mail transmission, or storage operation of the document is then commenced in accordance with the update data.

### BACKGROUND OF THE INVENTION

The subject application is directed generally to remotely-directed retransmission of aborted facsimile messages. The application is particularly useful in connection with facsimile messages that are sent from a station, such as a facsimile-forwarding aggregator or kiosk, when a user has left the station location and is unaware of an erroneous or aborted transmission, thereby allowing the user to correct the situation.

Many facsimile devices are shared, either in a workplace or in a public facsimile station such as an airport or hotel kiosk. When a user approaches a facsimile device and commences a facsimile operation, that user typically steps away from the device prior to completion of the facsimile transmission. In the event that there is an error or aborted facsimile transmission, the user may be unaware of such error for a considerable period of time. The user may also have been assessed a fee for the operation, even though it was not completed. Additionally, the user may not be in a position to correct and retransmit a facsimile message for an extended period of time.

### SUMMARY OF THE INVENTION

In accordance with one embodiment of the subject application, there is provided a system and method for remote facsimile message retransmission. At least one document is received for facsimile transmission, which document includes at least one of an electronic document and a tangible document, as well as identification data corresponding to a user associated with the facsimile transmission. Address data corresponding to at least one destination for the at least one document is received, and the facsimile transmission is commenced in accordance with the received address data. Whether there is a successful transmission is monitored, and a notification message is generated to the user in accordance with received identification data, which notification message includes information relative to a successful transmission of the at least one document in accordance with an output of the monitoring. Login data is received from an associated thin client interface, which login data includes data associated with the at least one document. Update data corresponding to an output of the monitoring that indicates a failure of a facsimile transmission of the at least one document in accordance with received address data is received via the thin client interface. Thereafter, a facsimile retransmission of the at least one document is commenced in accordance with received update data, an electronic mail transmission of the at least one document is commenced in accordance with received update data, or a storage operation of the at least one document is commenced in accordance with received update data.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a remote facsimile message retransmission system according to one embodiment of the subject application;

FIG. 2 is a block diagram illustrating device hardware for use in the remote facsimile message retransmission system according to one embodiment of the subject application;

FIG. 3 is a functional diagram illustrating the device for use in the remote facsimile message retransmission system according to one embodiment of the subject application;

FIG. 4 is a block diagram illustrating controller hardware for use in the remote facsimile message retransmission system according to one embodiment of the subject application;

FIG. 5 is a functional diagram illustrating the controller for use in the remote facsimile message retransmission system according to one embodiment of the subject application;

FIG. 6 is a block diagram illustrating the remote facsimile message retransmission system according to one embodiment of the subject application;

FIG. 7 is a functional diagram illustrating the remote facsimile message retransmission system according to one embodiment of the subject application;

FIG. 8 is a flowchart illustrating a remote facsimile message retransmission method according to one embodiment of the subject application; and

FIG. 9 is a flowchart illustrating a remote facsimile message retransmission method according to one embodiment of the subject application.

### DETAILED DESCRIPTION OF THE PREFERRED EMBODIMENT

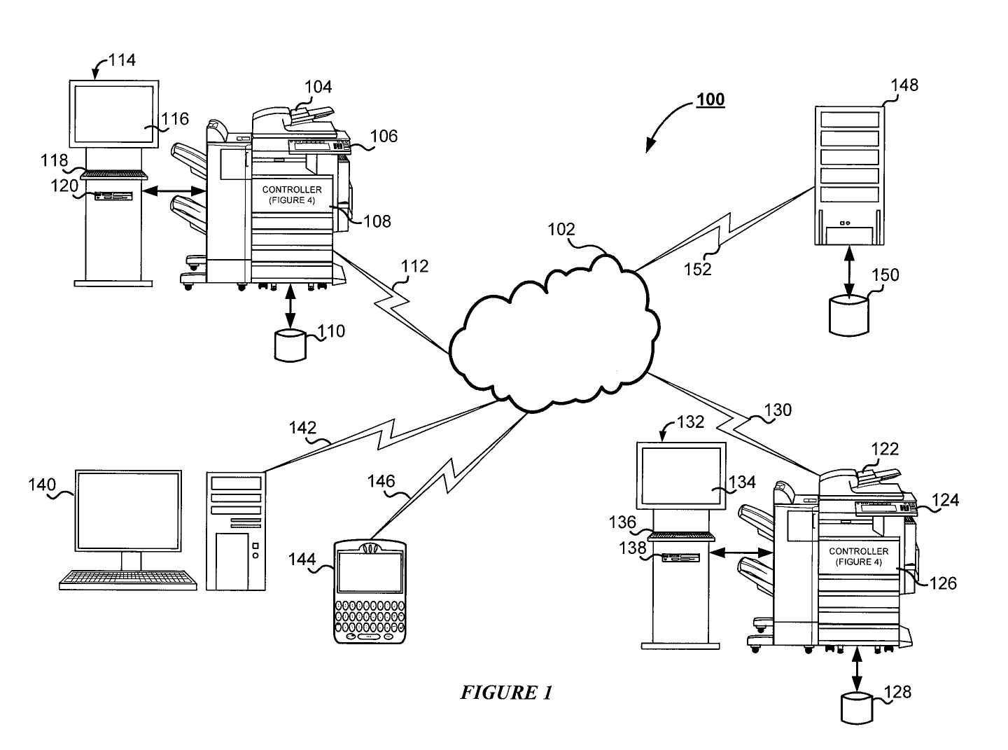

The subject application is directed to a system and method for remotely directed retransmission of aborted facsimile messages. In particular, the subject application is directed to a system and method for enabling a user to correct an error or aborted facsimile transmission from a remote location after initially sending a facsimile transmission from a station such as a kiosk. More particularly, the subject application allows a user to retransmit a facsimile transmission after leaving a station such as a kiosk, from which the facsimile transmission was originally sent. It will become apparent to those skilled in the art that the system and method described herein are suitably adapted to a plurality of varying electronic fields employing remote notifications including, for example and without limitation, communications, general computing, data processing, document processing, financial transactions, vending of products or services, and the like. The preferred embodiment, as depicted in FIG. 1, illustrates a document processing field for example purposes only and is not a limitation of the subject application solely to such a field.

Referring now to FIG. 1, there is shown an overall diagram of a system 100 for remote facsimile message retransmission in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The system 100 also includes a first document processing device 104 and a second document processing device 122, which are depicted in FIG. 1 as multifunction peripheral devices suitably adapted to perform a variety of document processing operations. It will be appreciated by those skilled in the art that such document processing operations include, for example and without limitation, facsimile, scanning, copying, printing, electronic mail, document management, document storage, and the like. Suitable commercially-available document processing devices include, for example and without limitation, the Toshiba e-Studio Series Controller. In accordance with one aspect of the subject application, the document processing devices 104 and 122 are suitably adapted to provide remote document processing services to external or network devices. Preferably, the document processing devices 104 and 122 include hardware, software, and any suitable combination thereof configured to interact with an associated user, a networked device, or the like.

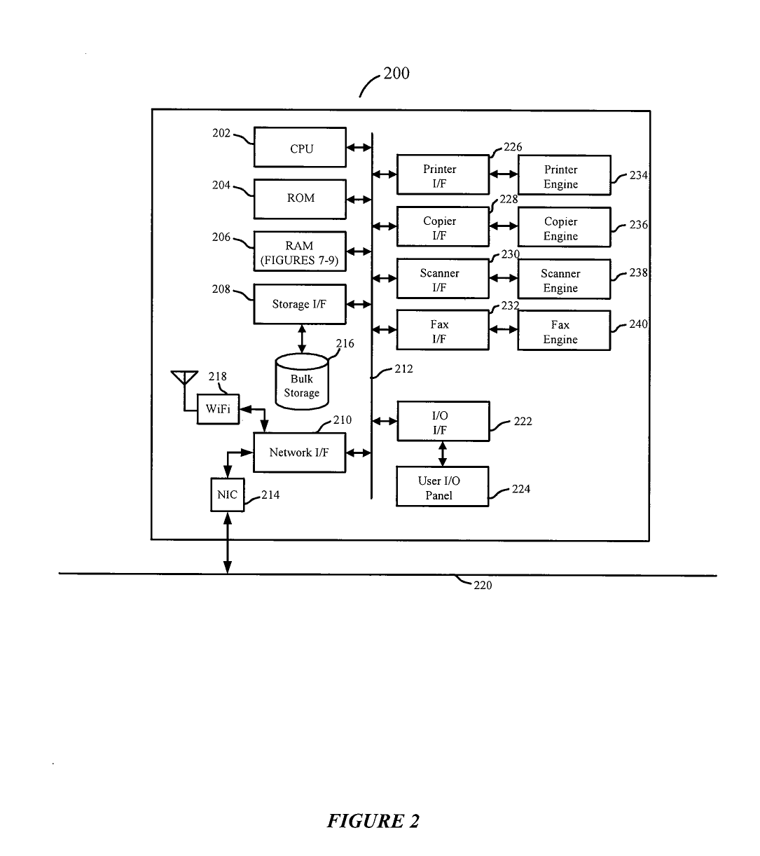

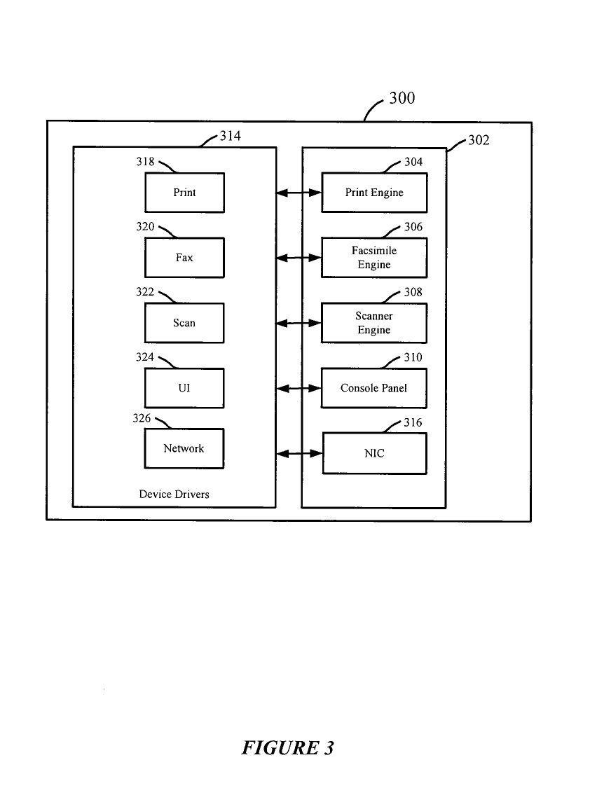

According to one embodiment of the subject application, the document processing devices 104 and 122 are suitably equipped to receive a plurality of portable storage media including, without limitation, Firewire drive, USB drive, SD, MMC, XD, compact flash, memory stick, and the like. In the preferred embodiment of the subject application, the document processing devices 104 and 122 further include an associated user interface 106 and 124 such as a touch-screen LCD display, touch-panel, alpha-numeric keypad, or the like, via which an associated user is able to interact directly with the corresponding document processing device 104 or 122. In accordance with the preferred embodiment of the subject application, the user interfaces 106 and 124 are advantageously used to communicate information to the associated user and receive selections from the associated user. The skilled artisan will appreciate that the user interfaces 106 and 124 comprise various components suitably adapted to present data to the associated user, as are known in the art. In accordance with one embodiment of the subject application, the user interfaces 106 and 124 comprise a display suitably adapted to display one or more graphical elements, text data, images, or the like to an associated user, to receive input from the associated user, and to communicate the same to the controllers 108 and 126, as explained in greater detail below. Preferably, the document processing devices 104 and 122 are communicatively coupled to the computer network 102 via respective communications links 112 and 130. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104 and 122 will be better understood in conjunction with the block diagrams illustrated in FIGS. 2 and 3, explained in greater detail below.

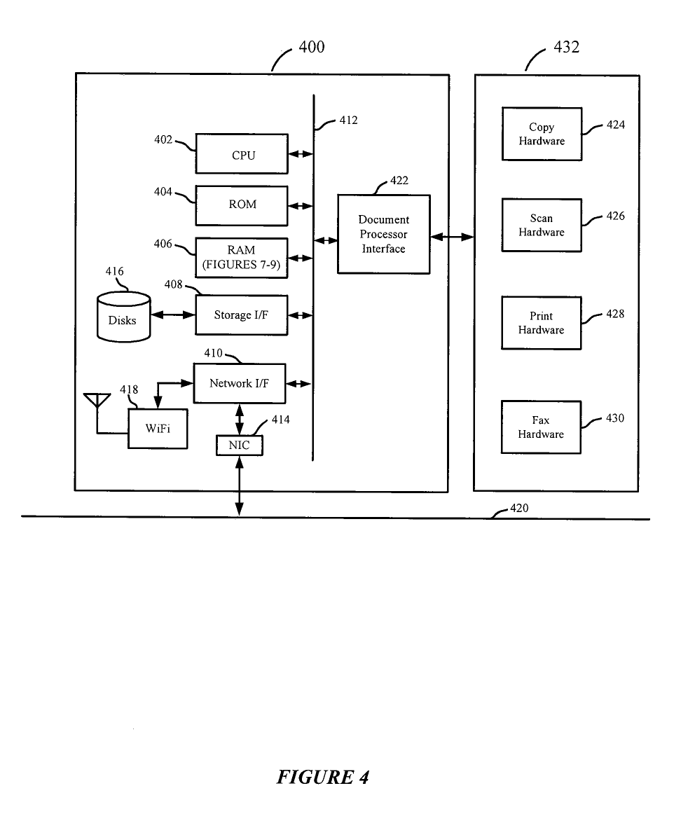

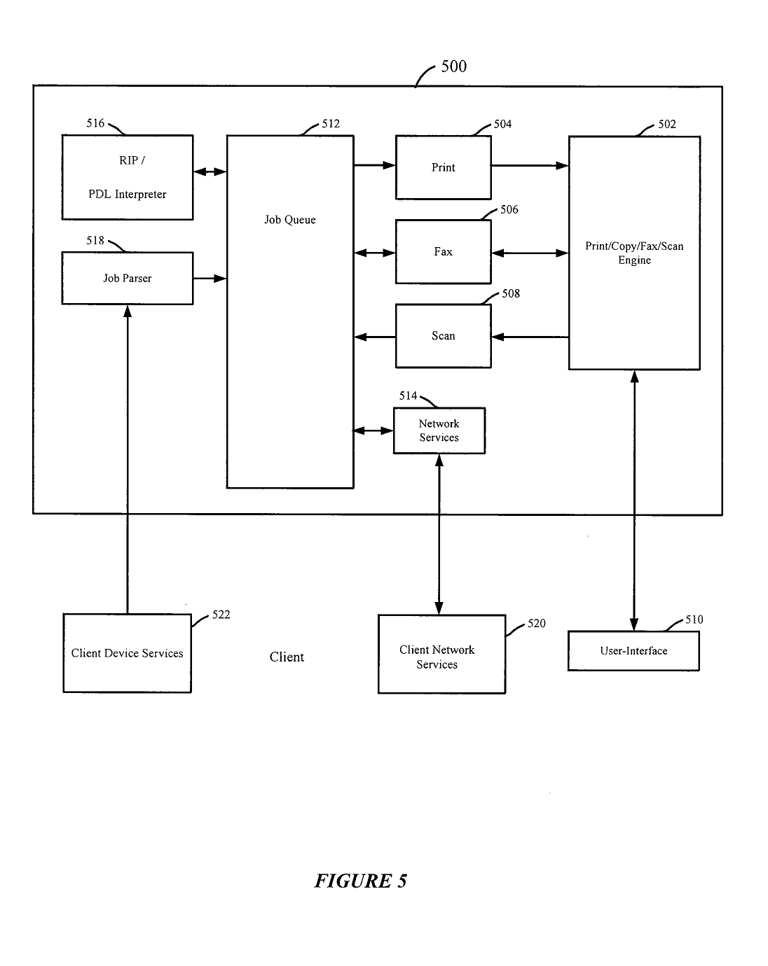

In accordance with one embodiment of the subject application, the document processing devices 104 and 122 each incorporate a control component, designated as the controllers 108 and 126, suitably adapted to facilitate the operations of the document processing devices 104 and 122, as will be understood by those skilled in the art. Preferably, the controllers 108 and 126 are embodied as hardware, software, or any suitable combination thereof configured to control the operations of the associated document processing device 104 or 122, to facilitate the display of images via the user interfaces 106 or 124, to direct the manipulation of electronic image data, and the like. For purposes of explanation, the controllers 108 and 126 are used to refer to any of the myriad components associated with the document processing device 104 or 122 including hardware, software, or combinations thereof functioning to perform, cause to be performed, control, or otherwise direct the methodologies described hereinafter. It will be understood by those skilled in the art that the methodologies described with respect to the controllers 108 and 126 are capable of being performed by any general purpose computing system known in the art, and thus the controllers 108 and 126 are representative of such general computing devices and are intended as such when used hereinafter. Furthermore, the use of the controllers 108 and 126 hereinafter is for the example embodiment only, and other embodiments, which will be apparent to one skilled in the art, are capable of employing the system and method for remote facsimile retransmission. The functioning of the controllers 108 and 126 will better be understood in conjunction with the block diagrams illustrated in FIGS. 4 and 5, explained in greater detail below.

Communicatively coupled to the document processing devices 104 and 122 are data storage devices 110 and 128, respectively. In accordance with the one embodiment of the subject application, the data storage devices 110 and 128 are any mass storage device known in the art including, for example and without limitation, magnetic storage drives, a hard disk drive, optical storage devices, flash memory devices, or any suitable combination thereof. In one embodiment, the data storage devices 110 and 128 are suitably adapted to store data records, user information, cellular telephone data, pre-set payment data, document data, image data, electronic database data, or the like. It will be appreciated by those skilled in the art that, while illustrated in FIG. 1 as being a separate component of the system 100, the data storage devices 110 and 128 are capable of being implemented as internal storage components of the document processing devices 104 and 122, components of the controllers 108 and 126, or the like such as, for example and without limitation, internal hard disk drives or the like. In accordance with one embodiment of the subject application, the data storage devices 110 and 128 are capable of storing document processing instructions, usage data, user interface data, job control data, controller status data, component execution data, images, advertisements, user information, location information, output templates, mapping data, multimedia data files, fonts, and the like.

Illustrated in FIG. 1 are kiosks 114 and 132 communicatively coupled to the document processing devices 104 and 122 and, in effect, the computer network 102. It will be appreciated by those skilled in the art that the kiosks 114 and 132 are capable of being implemented as separate components of the document processing devices 104 and 122 or as integral components thereof. Use of the kiosks 114 and 132 in FIG. 1 are for example purposes only, and the skilled artisan will appreciate that the subject application is capable of implementation without the use of the kiosks 114 and 132. In accordance with one embodiment of the subject application, the kiosks 114 and 132 include associated displays 116 and 134 and user input devices 118 and 136. As will be understood by those skilled in the art, the kiosks 114 and 132 are capable of implementing a combination user input device/display such as a touch screen interface. According to one embodiment of the subject application, the kiosks 114 and 132 are suitably adapted to display prompts to an associated user, to receive document processing instructions from the associated user, to receive payment data, to receive selection data from the associated user, and the like. Preferably, the kiosks 114 and 132 include a magnetic card reader, conventional bar code reader, or the like suitably adapted to receive and read payment data from a credit card, coupon, debit card, or the like.

The system 100 of FIG. 1 also includes portable storage device readers 120 and 138, respectively coupled to the kiosks 114 and 132, which are suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

Depicted in FIG. 1 is a user device 140, illustrated as a personal computer in data communication with the computer network 102 via a communications link 142. It will be appreciated by those skilled in the art that the user device 140 is shown in FIG. 1 as a computer workstation for illustration purposes only. As will be understood by those skilled in the art, the user device 140 is representative of any personal computing device known in the art including, for example and without limitation, a laptop computer, a personal computer, a personal data assistant, a web-enabled cellular telephone, a smart phone, a proprietary network device, or other web-enabled electronic device. The communications link 142 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the user device 140 is suitably adapted to receive status data, job data, user interface data, and/or image data; to monitor document processing jobs; to employ thin client interfaces; to generate display data; to generate output data; or the like with respect to the document processing devices 104 and 122 or any other similar device coupled to the computer network 102.

The system 100 illustrated in FIG. 1 further depicts a mobile user device 144 in data communication with the computer network 102 via a communications link 146. It will be appreciated by those skilled in the art that the mobile user device 144 is shown in FIG. 1 as a portable communications device for illustration purposes only. As will be understood by those skilled in the art, the mobile user device 144 is representative of any mobile personal communications device known in the art including, for example and without limitation, a personal data assistant, a web-enabled cellular telephone, a smart phone, a proprietary network device, or other web-enabled communications device. The communications link 146 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the mobile user device 144 is suitably adapted to send and receive text messages, to browse the Internet, to communicate user information and password data, to receive status or job data, or the like with respect to the document processing devices 104 and 122 or any other similar device coupled to the computer network 102.

The system 100 illustrated in FIG. 1 further depicts a backend component, shown as the server 148, in data communication with the computer network 102 via a communications link 152. It will be appreciated by those skilled in the art that the server 148 is shown in FIG. 1 as a component of the system 100 for example purposes only, and the subject application is capable of implementation without the use of a separate backend server component. The skilled artisan will appreciate that the server 148 comprises hardware, software, and combinations thereof suitably adapted to provide one or more services, facsimile-forwarding aggregation services, web-based applications, storage options, and the like to networked devices. In accordance with one example embodiment of the subject application, the server 148 includes various components, implemented as hardware, software, or a combination thereof, for managing retention of secured documents and text data, performing searches and comparisons, maintaining data records and account information, receiving payment data, retrieval of documents, and the like, which are accessed via the computer network 102. The communications link 152 is any suitable data communications means known in the art including but not limited to wireless communications comprising, for example and without limitation Bluetooth, WiMax, 802.11a, 802.11b, 802.11g, 802.11(x), a proprietary communications network, infrared, the public switched telephone network, optical, or any suitable wireless data transmission system or wired communications known in the art. It will further be appreciated by those skilled in the art that the components described with respect to the server 148 are capable of implementation on any suitable computing device coupled to the computer network 102, e.g. the controllers 108 and 126, or the like.

Communicatively coupled to the server 148 is the data storage device 150. According to the foregoing example embodiment, the data storage device 150 is any mass storage device, or plurality of such devices, known in the art including, for example and without limitation, magnetic storage drives, a hard disk drive, optical storage devices, flash memory devices, or any suitable combination thereof. In such an embodiment, the data storage device 150 is suitably adapted to store software updates, secured electronic documents, text data, data strings, account information, policy information, and the like. It will be appreciated by those skilled in the art that, while illustrated in FIG. 1 as being a separate component of the system 100, the data storage device 150 is capable of being implemented as an internal storage component of the server 148 or the like such as, for example and without limitation, an internal hard disk drive or the like.

Turning now to FIG. 2, illustrated is a representative architecture of a suitable device 200, shown in FIG. 1 as the document processing devices 104 and 122, on which operations of the subject system are completed. Included is a processor 202 suitably comprised of a central processor unit? However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data, used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device 300, depicted in FIG. 1 as the document processing devices 104 and 122, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical or non-physical layer such as wired, wireless, or optical data communication.

The document processing engine 302 is suitably in data communication with one or more device drivers 314, which device drivers 314 allow for data interchange from the document processing engine 302 to one or more physical devices so as to accomplish the actual document processing operations. Such document processing operations include one or more of printing via driver 318, facsimile communication via driver 320, scanning via driver 322 and user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable control component, i.e., the controller 400, shown in FIG. 1 as the controllers 108 and 126, on which operations of the subject system 100 are completed. The skilled artisan will understand that the controller 400 is representative of any general computing device known in the art that is capable of facilitating the methodologies described herein. Included is a processor 402 suitably comprised of a central processor unit; however, it will be appreciated that processor 402 may be advantageously composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data, used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing devices 104 and 122, which includes the controller 400 of FIG. 4 (shown in FIG. 1 as the controllers 108 and 126) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

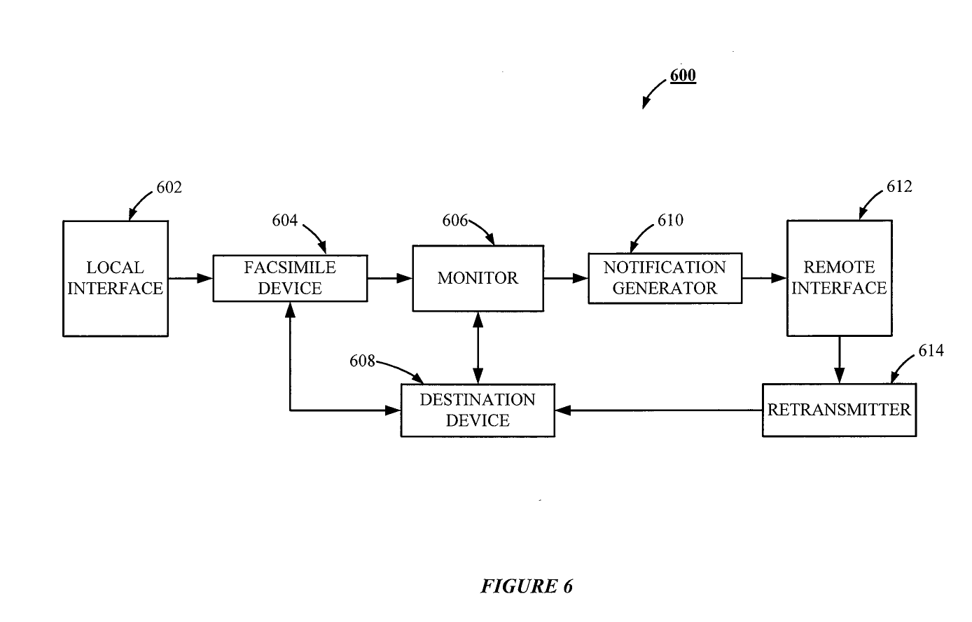

Turning now to FIG. 6, illustrated is a block diagram of a system 600 for remote facsimile message retransmission in accordance with one embodiment of the subject application. The system 600 includes a local interface 602, e.g. the user interface 106 or kiosk 114 associated with the first document processing device 104, via which an associated user is capable of submitting a document, including an electronic document or a tangible document for facsimile transmission to a destination device 608, such as the second document processing device 122. The local interface 602 is coupled to a facsimile device 604, e.g. a facsimile-forwarding aggregator or service provided by the backend server 148. In accordance with one embodiment of the subject application, the originating device, e.g. the local interface 602, forwards the 1o scanned image to the facsimile device 604, e.g. the backend server 148, for processing. In such an embodiment, the facsimile device 604, such as the backend server 148, reformats the image and forwards the document as a facsimile using standard ITU faxing protocols over the network 102, e.g. Internet, public switched telephone network, or the like. A monitor 606, such as the backend server 148, then monitors the transmission of the document from the facsimile device 604, e.g. the facsimile service of the server 148, to the destination device 608.

A notification generator 610 is then employed to generate a notification message to the user, e.g. a text message or electronic mail message to the user device 140 or the mobile user device 144, such that the notification message indicates the success or failure of the facsimile transmission of the document. Upon a failure message, the associated user, via the remote interface 612, instructs a retransmitter 614 to retransmit the document to the destination device 608. According to one embodiment of the subject application, the user, via a thin client interface associated with the remote interface 612, communicates retransmission instructions to the server 148, which functions as the retransmitter 614 to send the facsimile transmission again. In accordance with such an example embodiment of the subject application, the functioning of the server 148 as the retransmitter 614 is suitably accomplished via a fax forwarding service resident thereon. According to another embodiment of the subject application, the remote interface 612 supplies update data in the form of an electronic mail address, whereby the retransmitter 614 communicates the electronic document to a destination electronic mail address, e.g. destination device 608 becomes representative of an electronic mail account. In a further embodiment of the subject application, the update data supplied by the remote interface 612 corresponds to a destination storage location, wherein the retransmitter 614 forwards the electronic document to the storage destination, e.g. the destination device 608 becomes representative of a storage device.

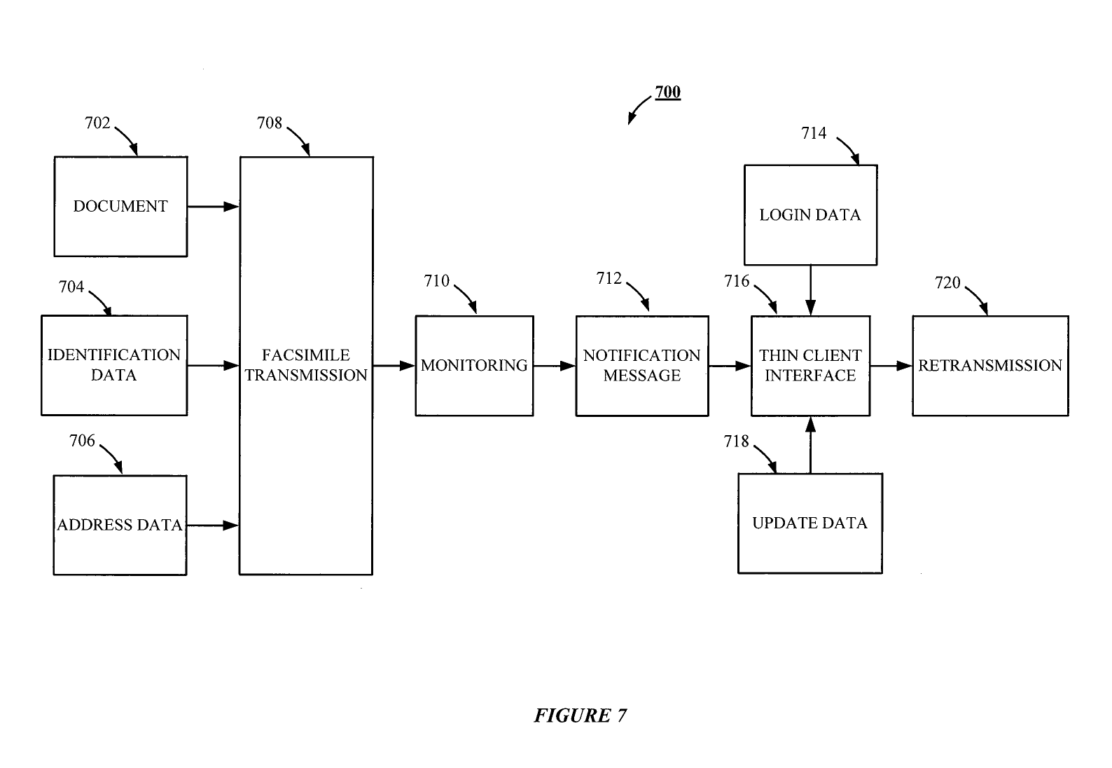

Referring now to FIG. 7, there is shown a functional diagram 700 illustrating the remote facsimile message retransmission system in accordance with one embodiment of the subject application. A document 702, identification data 704, and address data 706 are first received for a facsimile transmission 708. In accordance with one embodiment of the subject application, the document 702 includes an electronic document or a tangible document. The identification data 704 preferably includes, for example and without limitation, data corresponding to a user associated with the facsimile transmission 708 of the document 702. According to one embodiment of the subject application, the address data 706 includes, for example and without limitation, at least one destination for the document 702 as a result of the facsimile transmission 708.

Monitoring 710 is then performed as to whether a successful completion of the facsimile transmission 708 occurred. A notification message 712 is then generated, indicating the status of is the facsimile transmission 708 based upon the monitoring 710, i.e. whether the facsimile transmission 708 failed or was successfully completed. Preferably, such notification message 712 is communicated to an associated user, e.g. electronic mail or text message to the user device 140 or mobile user device 144. Thereafter, login data 714 is received from the associated user via the thin client interface 716. It will be appreciated by those skilled in the art that such a thin client interface 716 is capable of operation via the user device 140 or the mobile user device 144 such as, for example and without limitation, a web-browser. Update data 718 representing a corrected destination address, an electronic mail destination address, or a storage destination address (storage location), is received via the thin client interface 716 and thereafter a retransmission 720 is performed of the document to the destination based upon the received update data.

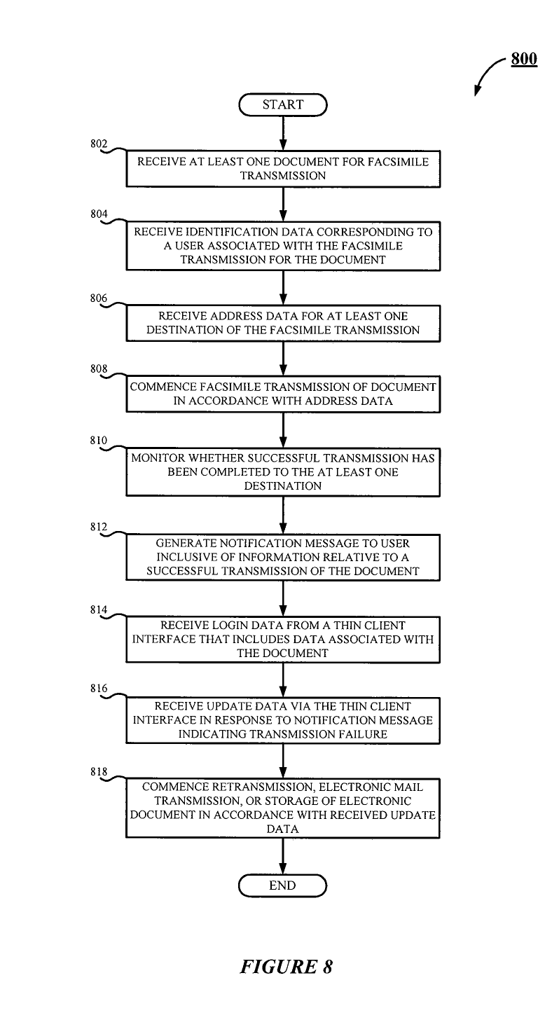

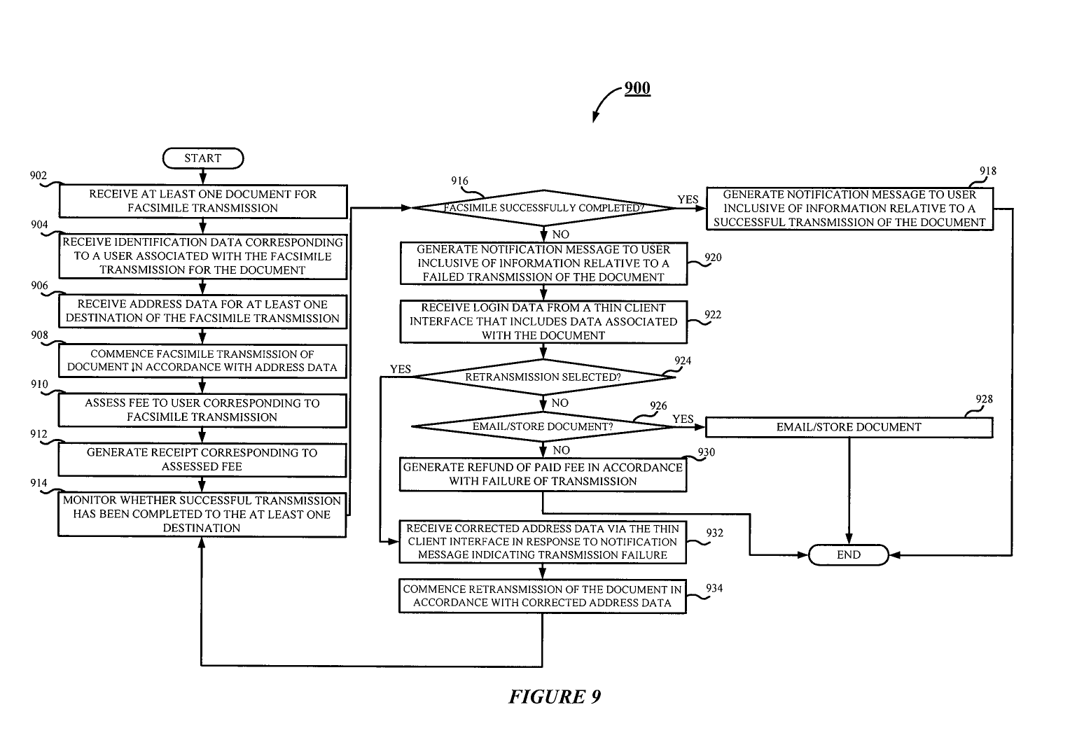

The skilled artisan will appreciate that the subject system 100 and components described above with respect to FIG. 1, FIG. 2, FIG. 3, FIG. 4, FIG. 5, FIG. 6, and FIG. 7 will be better understood in conjunction with the methodologies described hereinafter with respect to FIG. 8 and FIG. 9. Turning now to FIG. 8, there is shown a flowchart 800 illustrating a method for remote facsimile message retransmission in accordance with one embodiment of the subject application. Beginning at step 802, at least one document, such as an electronic document or a tangible document, is received by the first document processing device 104 for facsimile transmission. According to one embodiment of the subject application, a user via the kiosk 114 or user interface 106 associated with the first document processing device 104 requests the facsimile transmission of the document.

At step 804, identification data corresponding to the user associated with the facsimile transmission is received via the user interface 106, the kiosk 114, or other suitable component associated with the first document processing device 104. Address data is then received at step 806 corresponding to a desired destination for the document from the associated user. The skilled artisan will appreciate that such address data is capable of including, for example and without limitation, a telephone number associated with the second document processing device 122, a facsimile address associated with the second document processing device 122, or the like.

A facsimile transmission is then commenced at step 808 in accordance with the received address data. That is, the first document processing device 104 generates image data corresponding to the received document and forwards such data to the server 148 along with the received identification and address data for facsimile transmission by a facsimile service of the server 148 to the designated addressee. According to one example embodiment of the subject application, the controller 108 or other suitable component associated with the document processing device 104 initiates a facsimile transmission to the second document processing device 122 associated with the received address data. In accordance with one embodiment of the subject application, the server 148 receives the facsimile transmission from the first document processing device 104 and facilitates the delivery of the transmission to the second document processing device 122 designated by the address data. The server 148 then monitors, at step 810, whether or not a successful facsimile transmission has been completed to the second document processing device 122.

The server 148 or other suitable device coupled to the computer network 102 and monitoring such facsimile transmissions then generates a notification message at step 812 incorporating information relative to a successful transmission of the document. When the notification message generated by the server 148 indicates that the facsimile transmission of the document was unsuccessful, the user is capable of requesting retransmission from the server 148 to the second document processing device 122. Thus, at step 814, login data is received from the user via a thin client interface, including data representing the document of the facsimile transmission. That is, the user logs onto the server 148 via a thin client interface, e.g. web-browser, operable on the user device 140 of mobile user device 144. Update data is then received at step 816 from the user via the thin client interface. Thereafter, a facsimile retransmission of the document, an electronic mail transmission of the document, or a storage of the document is commenced by the server 148 at step 818 based upon the received update data.

Referring now to FIG. 9, there is shown a flowchart 900 illustrating a method for remote facsimile message retransmission in accordance with one embodiment of the subject application. The methodology of FIG. 9 begins at step 902, whereupon one or more documents, either in electronic or tangible form, are received by the first document processing device 104 for facsimile transmission from an associated user. At step 904, identification data is received by the controller 108 or other suitable component associated with the document processing device 104 from the associated user via the user interface 106, the kiosk 114, or the like. Preferably, the identification data includes data representing the user and the at least one document for facsimile transmission.

At step 906, address data is received from the user corresponding to the destination, e.g. intended recipient, of the facsimile transmission. It will be appreciated by those skilled in the art that such address data includes, for example and without limitation, a facsimile telephone number, a recipient device address, or the like. The skilled artisan will further appreciate that such address data is capable of being received via user input from the user interface 106, the kiosk 114, from an address database of the data storage device 110, from address information retrieved from the server 148, or the like. For example purposes only, reference is made hereinafter with respect to FIG. 9 of the second document processing device 122 being representative of the intended recipient of the facsimile transmission. The first document processing device 104 then commences transmission of the at least one document at step 908 in accordance with the address data. In accordance with one embodiment of the subject application, the document is communicated to the server 148 for facsimile transmission to the second document processing device 122 in accordance with the received address data. In such an embodiment, the skilled artisan will appreciate that the server 148 converts the received transmission of the document from the first document processing device 104 into a facsimile using standard ITU faxing protocols.

At step 910, the controller 108 or other suitable component associated with the document processing device 104 then calculates and assesses a fee associated with the facsimile transmission requested by the associated user. It will be appreciated by those skilled in the art that such fee is capable of being paid by the user via credit card, debit card, pre-paid account, billing account, or the like. The controller 108 or other suitable component associated with the document processing device 104 then generates, at step 912, a receipt corresponding to the assessed fee. The skilled artisan will appreciate that such receipt is capable of being issued by the server 148 and communicated to the user via the first document processing device 104, an electronic mail account associated with the user, or the like.

The server 148 or other suitable device coupled to the computer network 120 then monitors the facsimile transmission at step 914 so as to determine, at step 916, whether the facsimile transmission was successfully completed. That is, the server 148 attempts to communicate the document to the second document processing device 122 as a facsimile transmission in accordance with the address data received from the first document processing device 104. Upon a determination at step 916 that the facsimile transmission has been successfully completed, flow proceeds to step 918. At step 918, the server 148 or other suitable component monitoring the facsimile transmission then generates a notification message to the associated user inclusive of information relative to the successful transmission of the document. In accordance with one embodiment of the subject application, the server 148 generates an electronic mail message, a text message, or the like and communicates this message to the user device 140, the mobile user device 144, a cellular telephone associated with the user, or the like.

Upon a determination at step 916 that the facsimile transmission failed, flow proceeds to step 920. At step 920, a notification message is generated to the user inclusive of information relative to the failure of the facsimile transmission. According to one embodiment of the subject application, the server 148 or other suitable component associated with the system 100 generates an electronic mail message, an instant message, a text message, or the like to the user device 140, the mobile user device 144, or the like indicating that the facsimile transmission of the document was not successful.

Login data is then received from the associated user at step 922 that includes data associated with the document. Preferably, the login data is received via a thin client interface operable on the user device 140, the mobile user device 144, or the like, such as a web browser. The server 148 receives such login data at step 922 and a determination is made at step 924 as to whether the user has selected retransmission of the facsimile. When the user desires to retransmit the facsimile, flow proceeds to step 932, whereupon corrected address data is received from the user via the thin client interface of the user device 140 or mobile user device 144. Retransmission of the facsimile is then commenced by the server 148 in accordance with the corrected address data at step 934. Operations then return to step 914, whereupon the server 148 or other suitable device coupled to the computer network 102 monitors the facsimile transmission as set forth in greater detail above.

Upon a determination at step 924 that retransmission is not selected by the user, flow proceeds to step 926. At step 926, a determination is made as to whether the user has elected to electronically mail the document or store the document. That is, the user is presented with the ability to electronically mail the document to a desired recipient instead of faxing the document, or storing the document on the server 148 without transmitting the document. Preferably, the user is capable of selecting such an operation via the thin client interface operable on the user device 140 or the mobile user device 144. In the event that the user selects the electronic mail or storage operations, flow proceeds to step 928, whereupon the server 148 communicates the document to a designated mail addressee or stores the document on the data storage device 150 in accordance with the user instructions. The skilled artisan will appreciate that storage is also capable of being accomplished via the data storage device 110, the data storage device 128, or other such data storage device. Upon a determination at step 926 that the user has not selected an electronic mail or storage operation, flow proceeds to step 930. At step 930, a refund of the assessed fee is generated to the user in accordance with the failed facsimile transmission. Thereafter, operations with respect to FIG. 9 terminate.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application, to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A remote facsimile message retransmission system, comprising:
a local interface, which interface,
receives a facsimile transmission for at least one document, which document includes at least one of an electronic document and a tangible document,
receives identification data corresponding to a user associated with a facsimile transmission for the at least one document, and
receives address data corresponding to at least one destination for the at least one document;
a facsimile device, which facsimile device transmits the at least one document in accordance with received address data;
a monitor, which monitor monitors whether a successful transmission of the at least one document has been completed to the at least one destination;
a notification generator, which notification generator generates a notification message to the user in accordance with received identification data, and which notification message includes information relative to a successful transmission of the at least one document in accordance with an output of the monitor;
a remote interface, which remote interface,
receives login data from an associated thin client interface, which login data includes data associated with the at least one document, and
receives update data corresponding to an output of the monitor indicating a failure of a facsimile transmission of the at least one document in accordance with received address data; and
a re-transmitter, which re-transmitter commences a retransmission of the at least one document in accordance with received update data.

2. The system of claim 1, wherein the notification generator generates the notification message as a text message.

3. The system of claim 2, wherein the text message is contained in an electronic mail.

4. The system of claim 1, further comprising a fee generator that generates a fee to the user in accordance with a facsimile transmission of the at least one document.

5. The system of claim 4, further comprising a refund generator that generates a refund of the fee to the associated user in accordance with a failure of a facsimile transmission for the at least one electronic document for which no retransmission is made.

6. The system of claim 5, further comprising a receipt generator that generates a receipt to the user in accordance with an assessed fee.

7. A remote facsimile message retransmission method, comprising the steps of:
receiving for facsimile transmission at least one document, which document includes at least one of an electronic document and a tangible document;
receiving identification data corresponding to a user associated with a facsimile transmission for the at least one document;
receiving address data corresponding to at least one destination for the at least one document;
commencing a facsimile transmission of the at least one document in accordance with received address data;
monitoring whether a successful transmission of the at least one document has been completed to the at least one destination;
generating a notification message to the user in accordance with received identification data, which notification message includes information relative to a successful transmission of the at least one document in accordance with an output of the monitoring;
receiving login data from an associated thin client interface, which login data includes data associated with the at least one document;
receiving, via the thin client interface, update data corresponding to an output of the monitoring indicating a failure of a facsimile transmission of the at least one document in accordance with received address data; and
commencing at least one of the group consisting of a facsimile retransmission of the at least one document in accordance with received update data, an electronic mail transmission of the at least one document in accordance with received update data, and a storage operation of the at least one document in accordance with received update data.

8. The method of claim 7, wherein the notification step includes generating the notification message as a text message.

9. The method of claim 7, wherein the text message is contained in an electronic mail.

10. The method of claim 7, further comprising the step of assessing a fee to the user in accordance with a facsimile transmission of the at least one document.

11. The method of claim 10, further comprising the step of generating a refund of the fee to the associated user in accordance with a failure of a facsimile transmission for the at least one electronic document for which no retransmission is made.

12. The method of claim 10, further comprising the step of generating a receipt to the user in accordance with an assessed fee.

13. A remote facsimile message retransmission system, comprising:
means adapted for receiving for facsimile transmission at least one document, which document includes at least one of an electronic document and a tangible document;
means adapted for receiving identification data corresponding to a user associated with a facsimile transmission for the at least one document;
means adapted for receiving address data corresponding to at least one destination for the at least one document;
means adapted for commencing a facsimile transmission of the at least one document in accordance with received address data;
monitoring means adapted for monitoring whether a successful transmission of the at least one document has been completed to the at least one destination;
notification means adapted for generating a notification message to the user in accordance with received identification data, which notification message includes information relative to a successful transmission of the at least one document in accordance with an output of the monitoring means;
means adapted for receiving login data from an associated thin client interface, which login data includes data associated with the at least one document;
means adapted for receiving, via the thin client interface, update data corresponding to an output of the monitoring means indicating a failure of a facsimile transmission of the at least one document in accordance with received address data; and
means adapted for commencing at least one of the group consisting of a facsimile retransmission of the at least one document in accordance with received update data, an electronic mail transmission of the at least one document in accordance with received update data, and a storage operation of the at least one document in accordance with received update data.

14. The system of claim 13, wherein the notification means includes means adapted for generating the notification message as a text message.

15. The system of claim 14, wherein the text message is contained in an electronic mail.

16. The system of claim 13, further comprising means adapted for assessing a fee to the user in accordance with a facsimile transmission of the at least one document.

17. The system of claim 16, further comprising means adapted for generating a refund of the fee to the associated user in accordance with a failure of a facsimile transmission for the at least one electronic document for which no retransmission is made.

18. The system of claim 16, further comprising means adapted for generating a receipt to the user in accordance with an assessed fee.
